(19) United States
(12) Patent Application Publication
(10) Pub. No.: US 2010/0211801 A1
(43) Pub. Date: Aug. 19, 2010

(54) DATA STORAGE DEVICE AND DATA MANAGEMENT METHOD THEREOF

(75) Inventors: Byung-Gook KIM, Hwaseong-si (KR); Ji Soo KIM, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/693,561

(22) Filed: Jan. 26, 2010

(30) Foreign Application Priority Data
Feb. 19, 2009 (KR) 10-2009-0014044

(51) Int. Cl. G06F 12/14; H04L 9/28

(52) U.S. Cl. 713/189; 380/28

(57) ABSTRACT

Provided is a data storage device including: a storage medium that stores a first type of cipher text; and a storage controller that forms the first type of cipher text by scattering a second type of cipher text in a plurality of random numbers and that transfers the first type of cipher text to the storage medium through an internal bus or an external bus.

### CROSS-REFERENCE TO RELATED APPLICATION

This U.S. non-provisional patent application claims priority under 35 U.S.C. §119 of Korean Patent Application 10-2009-0014044, filed on Feb. 19, 2009, the entire contents of which are hereby incorporated by reference.

### BACKGROUND OF THE INVENTIVE CONCEPT

The present disclosure herein relates to a data storage device, and more particularly, to a data storage device having security function and a data management method thereof.

With the advent of the information society, amounts of data that individuals store and carry have tremendously increased. With an increase in the demand for a data storage medium, a variety of individual data storage devices have been developed.

Among the data storage devices, a hard disk drive (HDD) has been widely used due to a high record density, a high data transmission speed, a fast data access time, low cost, and the like. However, since the hard disk drive has a complicated structure of mechanical components, a problem arises in that the hard disk drive may be broken down by small impact and vibration.

In recent years, a solid state disk (hereinafter, referred to as an SSD) using a flash memory has been developed as a data storage device that can replace the hard disk drive. Unlike the hard disk drive, the SSD has no mechanical structure. Therefore, the SSD can reduce latency and mechanical drive time compared to the hard disk drive and can execute reading/writing operations at a high speed. Since the SSD can reduce errors caused by latency and mechanical friction, it can improve reliability of the reading/writing operations. Moreover, since heat and noise rarely occur during the operation of the SSD and the SSD is largely resistant to external impacts, the SSD is estimated to be suitable for a portable device, compared to the known hard disk drive.

### SUMMARY OF THE INVENTIVE CONCEPT

The present disclosure provides a data storage device capable of securely storing and restoring cipher text without exposing it to the outside and a data management method thereof.

The present disclosure also provides a data storage device capable of protecting cipher text against unauthorized access or attack from the outside even without providing an additional unit and a data management method thereof.

Embodiments of the inventive concept provide a data storage device including: a storage medium that stores a first type of cipher text; and a storage controller that forms the first type of cipher text by scattering a second type of cipher text in a plurality of random numbers and that transfers the first type of cipher text to the storage medium through an internal bus or an external bus.

In some embodiments, the storage controller may include: an internal memory accessing through the internal bus; an encryption/decryption unit forming the second type of cipher text from plain text; and a memory control unit controlling a reading, erasing, or reading operation of the internal memory and forming the first type of cipher text from the second type of cipher text.

In some embodiments, the memory control unit may scatter the second type of cipher text in predetermined areas of the internal memory by using a mapping table.

In some embodiments, the mapping table may be formed using a unique number defined with each different value for every data storage device as a root key.

In some embodiments, the mapping table may not be stored in the data storage device.

In some embodiments, the memory control unit may restore the second type of cipher text from the first type of cipher text into by forming a mapping table identical to the formed mapping table used for scattering the second type of cipher text.

In some embodiments, the encryption/decryption unit may decrypt the second type of restored cipher text to the plain text.

In some embodiments, the data storage device may further include an external memory accessing through the external bus. The external memory may store the first type of cipher text transferred between the internal memory and the storage medium.

Other embodiments of the inventive concept provide a data management method of a data storage device including: forming a mapping table by using a unique number defined with each different value for every data storage device as a root key; allotting predetermined areas of an internal memory; writing random numbers in the allotted areas; scattering and storing cipher text to the allotted areas in which the random numbers are written; and writing the scattered and stored cipher text in a storage medium through an internal bus or an external bus.

Still other embodiments of the inventive concept provide a data management method of a data storage device including: copying a first type of cipher text from a storage medium to an internal memory through an internal bus or an external bus; forming a mapping table by using a unique number defined with each different value every data storage device as a root key; restoring a second type of cipher text from the first type of cipher text with reference to the mapping table; and decrypting the second type of restored cipher text to plain text. The first type of cipher text is formed by scattering and storing the second type of cipher text in a plurality of random numbers.

### BRIEF DESCRIPTION OF THE DRAWINGS

The accompanying drawings are included to provide a further understanding of the inventive concept, and are incorporated in and constitute a part of this specification. The drawings illustrate example embodiments of the inventive concept and, together with the description, serve to explain principles of the inventive concept. In the drawings:

FIG. 1 is a block diagram illustrating the overall configuration of a data storage device according to an embodiment of the inventive concept and a storage system including the data storage device;

FIG. 2 is a diagram illustrating the detailed configuration of a storage controller illustrated in FIG. 1;

FIG. 3 is a diagram illustrating a method of forming a cipher text according to the embodiment of the inventive concept;

FIG. 4 is a diagram illustrating a method of decrypting cipher text formed using an internal memory and random numbers to plain text according to the embodiment of the inventive concept;

FIG. 5 is a flowchart illustrating a method of scattering and storing the cipher text according to the embodiment of the inventive concept;

FIG. 6 is a flowchart illustrating a method of decrypting the cipher text according to the embodiment of the inventive concept; and

FIG. 7 is a diagram illustrating the configuration of a computing system according to the embodiment of the inventive concept.

### DETAILED DESCRIPTION OF PREFERRED EMBODIMENTS

An exemplary embodiment of the inventive concept will be described in detail in conjunction with the accompanying drawings. However, the following embodiment of the circuit configuration and operation of a data storage device according to the exemplary embodiment of the inventive concept are just exemplified and may, of course, be changed and modified in many different forms within the scope of the technical scope of the inventive concept.

In order to securely store and decrypt the encrypted cipher text without exposing the cipher text to the outside, a data storage device according to the embodiment of the inventive concept scatters the cipher text in a plurality of random numbers and stores the cipher text. Since the cipher text transferred through internal/external buses of the data storage device is mixed with the random numbers, the cipher text may be securely stored and decrypted without being exposed to the outside.

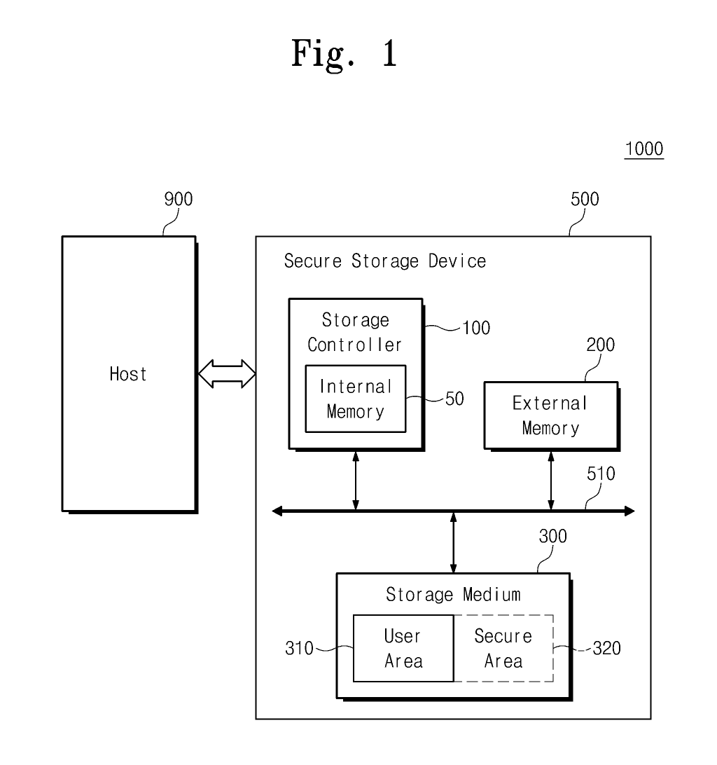

FIG. 1 is a block diagram illustrating the overall configuration of a data storage device 500 according to an embodiment of the inventive concept and a storage system 1000 including the data storage device. In FIG. 1, an SSD will be described as an example of the data storage device 500 according to the embodiment of the inventive concept. However, the embodiment of the inventive concept may be applicable to a hard disk, flash memory card/system, etc. that execute a data securing function through encryption.

Referring to FIG. 1, the storage system 1000 according to the embodiment of the inventive concept includes a host 900 and a data storage device 500. The data storage device 500 includes a storage controller 100, an external memory 200, and a storage medium 300.

The storage medium 300 may store data using semiconductor memory chips, instead of a plater of a hard disk drive (HDD). The storage medium 300 may be divided into a user area 310 storing user data and a secure area 320 storing cipher text encrypted. As illustrated in FIG. 1, the data storage device 500 has a function of storing the cipher text and is called a secure data storage device.

The storage medium 300 may be constituted by a nonvolatile memory such as a flash memory. One or more channels (for example, N channels) may be formed between the storage controller 100 and the storage medium 300. A plurality of flash memories may electrically be connected to each of the channels. In the embodiment of the inventive concept, the storage medium 300 is constituted by the flash memories, but the nonvolatile memory applied to the storage medium 300 may be formed in a variety of kinds without being limited to specific kinds or specific shapes. For example, the nonvolatile memory applied to the storage medium 300 may include the MRAM and the PRAM in addition to the flash memory. In addition, the storage medium 300 may be constituted by a volatile memory such as a DRAM or a SRAM.

The number of data bits stored in each memory cell of the storage medium 300 may be various. For example, the storage medium 300 may be constituted by single-level flash memory cells in which 1-bit data is stored per cell or multi-level flash memory cells in which multi-bit data are stored per cell. Alternatively, the storage medium 300 may be constituted by a combined type of the single-level flash memory cells and the multi-level flash memory cells. Various kinds of memory cells forming the storage medium 300 may be used in various forms. For example, the storage medium 300 may be constituted by NAND flash memory cells or NOR flash memory cells. Alternatively, the storage medium 300 may be constituted by a combined type of the NAND flash memory cells and the NOR flash memory cells. In addition, the storage medium 300 may be constituted by One-NAND flash memories in which a flash memory core and memory control logic are formed into a single chip.

The structure of a charge storage layer of the memory cells, which form the storage medium 300, may be formed in various shapes. For example, the charge storage layer of the memory cell may be made of conductive multi-crystalline silicon and may be formed using an insulating layer made of Si₃N₄, Al₂O₃, HfAlO, HfSiO, or the like. The structure of a flash memory using the insulating layer made of Si₃N₄, Al₂O₃, HfAlO, HfSiO, or the like as the charge storing layer is also called a charge trap flash (CTF) memory.

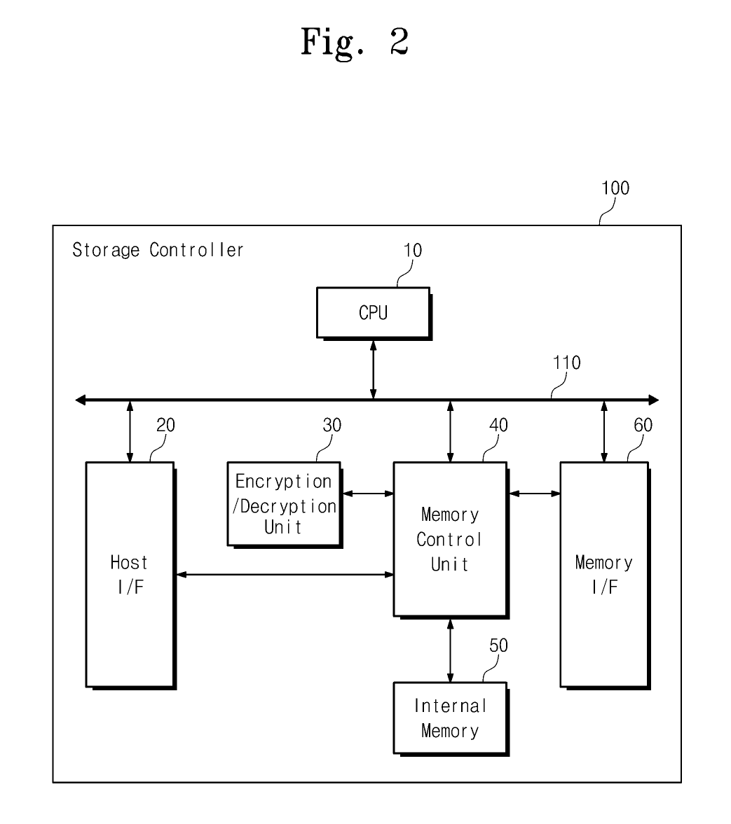

The storage controller 100 controls writing, erasing, and reading operations of the storage medium 300 and the external memory 200 in response to a command input from the host 900. The storage controller 100 includes an internal memory 50. The external memory 200 may be accessed through an external bus 510 or an external interface. On the other hand, the internal memory 50 may be accessed through an internal bus 110 (see FIG. 2) or an internal interface of the storage controller 100, but may not be accessed through the external bus 510 or the external interface.

The external memory 200 may store data to be stored in the storage medium 300 or a large amount of data read from the storage medium 300. The internal memory 50 may execute a function of buffering data that will be supplied to/from the external memory 200 in a predetermined data unit. The internal memory 50 has a data storage capacity smaller than that of the external memory 200, but operates at a speed faster than that of the external memory 200. The internal memory 50 and the external memory 200 may be formed of a high-speed volatile memory such as the SRAM or the DRAM. When the capacity of the internal memory 50 provided in the storage controller 100 is large, the external memory 200 may not be provided in the data storage device 500.

As described in detail below, the data storage device 500 allots predetermined areas to the internal memory 50 of the storage controller 100 to store the random numbers. Subsequently, the encrypted cipher texts are scattered and stored in the areas of the internal memory 50 in which the random numbers are stored. The cipher texts scattered and stored in the internal memory 50 are transferred through the internal bus and the external bus of the storage controller 100 and are stored in the secure area 320 of the storage medium 300. In the embodiment of the inventive concept, the data stored in the internal memory 50, the external memory 200, and the secure area 320 have a form in which the cipher texts are scattered and stored to the random numbers. The data transferred to the internal memory 50, the external memory 200, and the secure area 320 through the internal bus and the external bus of the storage controller 100 also have a form in which the cipher texts are scattered and stored to the random numbers.

In the embodiment of the inventive concept, as described above, the cipher texts are not directly transferred through the internal bus and the external bus of the storage controller 100, but are transferred such that the cipher texts are scattered and stored to the random numbers. In this configuration, an attacker can not recognize or analyze the cipher texts scattered and stored to the random numbers. Accordingly, the cipher texts are not exposed to the unauthorized access or attack from the outside of the data storage device 500.

FIG. 2 is a diagram illustrating the detailed configuration of the storage controller 100 illustrated in FIG. 1.

Referring to FIG. 2, the storage controller 100 includes a central processing unit 10 (hereinafter, referred to as CPU), a host interface 20 (referred to as a host I/F in the drawing), an encryption/decryption unit 30, a memory control unit 40, the internal memory 50, a memory interface 60 (referred to as a memory I/F in the drawing), and the internal bus 110. The CPU 10, the host interface 20, the memory control unit 40, the internal memory 50, and the memory interface 60 are connected to each other through the internal bus 110.

The CPU 10 controls various operations of the data storage device 500. The host interface 20 exchanges commands, addresses, and data with the host 900 in accordance with the control of the CPU 10. The host interface 20 may support one of various interfaces such as a USB (Universal Serial Bus), an MMC (Multi Media Card), a PCI-E (PCI Express), an ATA (AT Attachment), an SATA (Serial AT Attachment), a PATA (Parallel AT Attachment), an SCSI (Small Computer System Interface), an SAS (Serial Attached SCSI), an ESDI (Enhanced Small Disk Interface), and an IDE (Integrated Drive Electronics).

The data input through the host interface 20 are temporarily stored in the internal memory 50 and then sent to the storage medium 300 through the memory interface 60 under the control of the CPU 10. The data read from the storage medium 300 are temporarily stored in the internal memory 50 and then output to the outside through the host interface 20 under the control of the CPU 10. The data that are stored/will be stored in the internal memory 50 may be supplied from/to the external memory 200. However, the external memory 200 may not be provided or the access to the external memory 200 may be omitted when the capacity of the internal memory 50 is large enough.

The memory control unit 40 controls access operations (for example, reading, writing, and erasing operations) of the internal memory 50 and the external memory 200 in response to the control of the CPU 10. The internal memory 50 and the external memory 200 may be realized by a volatile memory (for example, SRAM or DRAM). The internal memory 50 and the external memory 200 temporarily store data that are read/will be read to/from the storage medium 300, that is, one of non-encrypted plaintext and encrypted cipher text. The internal memory 50 additionally executes a function of storing programs or firmwares that are operated by the CPU 10.

The memory interface 60 executes data transmission and reception between the internal memory 50 and the storage medium 300 and executes data transmission and reception between the internal memory 50 and the external memory 200. Both the internal bus 110 and the external bus 510 are used for the data transmission and reception. For example, the internal memory 50 executes the data transmission and reception through the internal bus 110 of the storage controller 100. On the other hand, the external memory 200 executes the data transmission and reception through the external bus 510 of the storage controller 100.

The encryption/decryption unit 30 is connected to the memory control unit 40 to form and decrypt the chipper text in accordance with a predetermined encryption algorithm. For example, the encryption/decryption unit 30 may encrypt the plain texts into the cipher texts by using a predetermined encryption algorithm. Moreover, the encryption/decryption unit 30 may decrypt the encrypted cipher texts into the plain texts.

The cipher texts encrypted by the encryption/decryption unit 30 are scattered and stored to the random numbers written in the predetermined areas of the internal memory 50 under the control of the memory control unit 40. The cipher texts scattered and stored in the predetermined areas of the internal memory 50 are written in the storage medium 300 through the internal memory 50 and the external memory 200 under the control of the memory control unit 40.

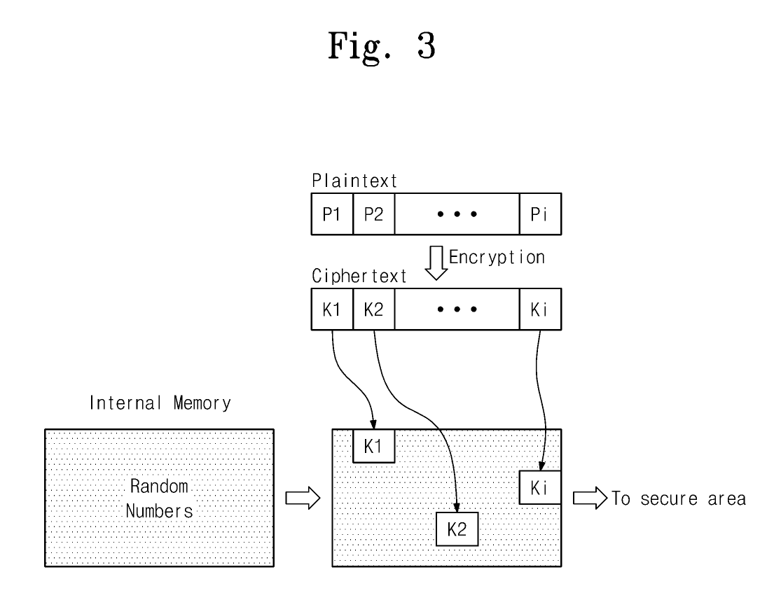

FIG. 3 is a diagram illustrating a way forming the cipher text according to the embodiment of the inventive concept.

Referring to FIG. 3, the memory control unit 40 first forms a mapping table that is used in scattering and storing the cipher text. The mapping table may be formed using a predetermined function that employs a unique number defined with different value for every data storage device 500 as a root key. The memory control unit 40 allots the predetermined areas storing the cipher texts to the internal memory 50. For example, the cipher text (K1, K2, . . . , Ki) encrypted from the plain text (P1, P2, . . . , Pi) are formed with 16 bytes. Areas of about 4K bytes may be allotted to the internal memory 50. The memory control unit 40 fills all the areas (for example, data storage areas of 4K bytes) allotted to the internal memory 50 with the plurality of random numbers. Then, the cipher text (K1, K2, . . . , Ki) are separated in predetermined data unit (for example, one byte) to be scattered and stored in the internal memory 50 filled with the random numbers. The previously formed mapping table determines the locations where the separated cipher text (K1, K2, . . . , Ki) are stored in the internal memory 50. At this time, the mapping table used in scattering and storing the cipher text is not separately stored for ensuring the secret. The storage controller 100 executes the operation of forming the mapping table and the operation of scattering and storing the cipher text in accordance with the mapping table.

The cipher text (K1, K2, . . . , Ki) scattered and stored to the random numbers in the internal memory 50 may be transferred to the external memory 200 through the internal bus 110 and the external bus 510 of the data storage device 500. When a great quantity of data is transferred between the internal memory 50 and the external memory 200, the data are separated in a predetermined unit to be transferred. In transferring the data through the internal bus 110 and the external bus 510, the cipher texts are not transferred directly, but transferred in the form mixed with the random numbers. The cipher texts transferred through the internal bus 110 and the external bus 510 may simply be recognized as the random numbers as viewed from the outside. Accordingly, the cipher texts, which are transferred through the internal bus 110 and the external bus 510 of the data storage device 500, are not exposed to the unauthorized access or the attack from the outside of the data storage device 500. In this case, as the size of the areas allotted to the internal memory 50 is larger, the security of the cipher texts is further ensured.

The scattered and stored cipher texts transferred to the external memory 200 are temporarily stored in the external memory 200 and then stored in the secure area 320 of the storage medium 300. The temporarily storing operation of the external memory 200 may be omitted when the capacity of the internal memory 50 is large enough.

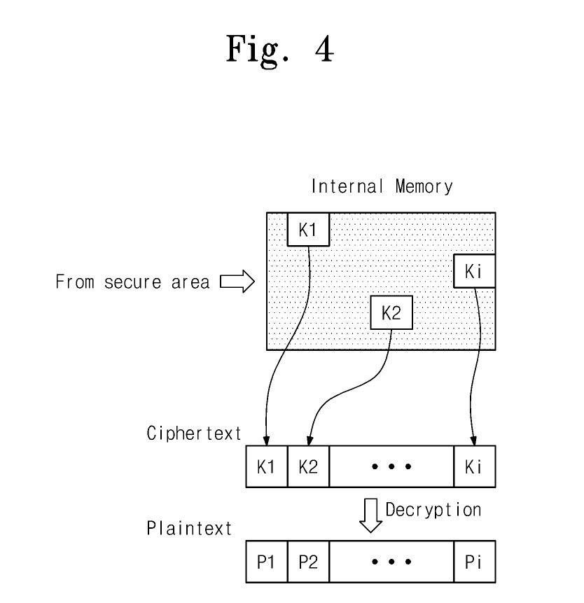

FIG. 4 is a diagram illustrating a method of decrypting the cipher text formed using the internal memory 50 and the random numbers to the plain text according to the embodiment of the inventive concept.

Referring to FIG. 4, the data stored in the secure area 320 of the storage medium 300 are identical to the cipher texts scattered to the random numbers. The cipher texts scattered and stored to the random numbers are transferred from the external memory 200 to the internal memory 50 through the external bus 510 and the internal bus 110 of the storage controller 100. The data stored in the external memory 200 and the internal memory 50 is identical to the cipher texts scattered to the random numbers. When a great quantity of data is transferred between the external memory 200 and the internal memory 50, the data may be separated in a predetermined unit to be transferred.

In restoring the data, the memory control unit 40 forms a mapping table that is used to restore the original cipher text from the cipher texts scattered and stored in the internal memory 50. The mapping table that is used to restore the cipher texts obtains the same mapping result as the mapping table that is used to scatter and store the cipher texts. In the embodiment of the inventive concept, the mapping table is formed using a predetermined function that employs a unique number defined with different value every data storage device 500 as a root key. The mapping table that is used to scatter, store, and decrypt the cipher texts may be defined by Equation 1.

Location of Ki=M(Root Key, i) [Equation 1]

According to the method of forming the mapping table of the embodiment of the inventive concept, it is possible to form the mapping table having a unique form every data storage device 500. Since the mapping table is formed automatically by the predetermined function, it is not necessary to separately store the formed mapping table. When the mapping table is not separately stored, a danger of information leakage caused by the outside attack is reduced.

The memory control unit 40 uses the mapping table to restore the original cipher texts (K1, K2, . . . , Ki) from the cipher texts scattered and stored in the internal memory 50. For example, the memory control unit 40 restores 16-byte cipher texts (K1, K2, . . . , Ki) from the 4K-byte data formed by scattering and storing the cipher texts with reference to the mapping table. The restored 16-byte cipher texts (K1, K2, . . . , Ki) are decrypted to the plain text (P1, P2, . . . , Pi) by the encryption/decryption unit 30. A cipher text decrypting algorithm applied to the encryption/decryption unit 30 is not limited to the specific form, but may be formed in various forms.

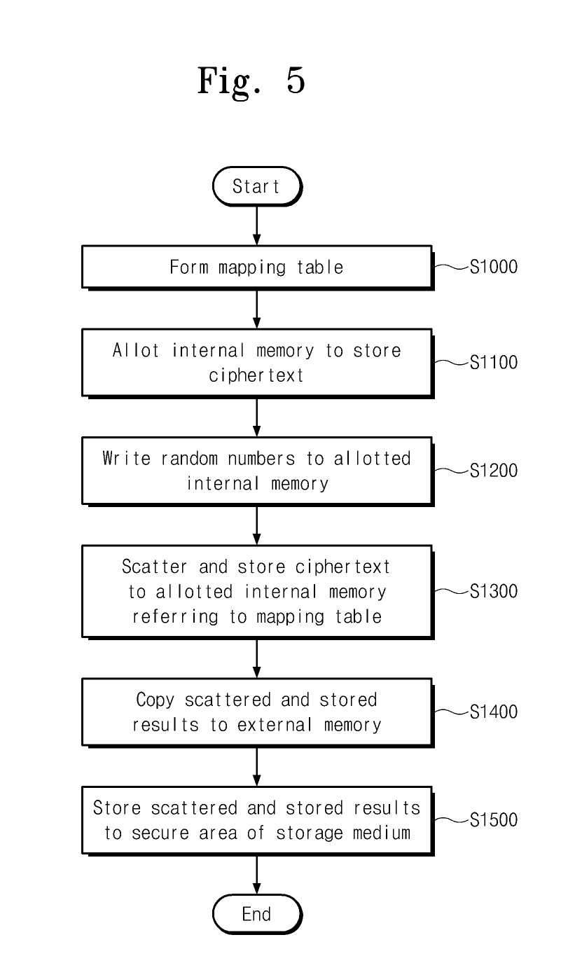

FIG. 5 is a flowchart showing a method of scattering and storing the cipher texts according to the embodiment of the inventive concept.

Referring to FIG. 5, the mapping table is first formed to scatter and store the cipher texts (S 1000). The mapping table is formed using a unique number defined with each different value every data storage device 500 as the root key. Subsequently, the memory control unit 40 allots the predetermined areas (for example, 4K-type data storage area) to the internal memory 50 to scatter and store the cipher texts (S1100). In this case, as the size of the areas allotted to the internal memory 50 is larger, the security of the cipher texts is further ensured. The plurality of random numbers is written in all the areas allotted to the internal memory 50 (S1200).

The memory control unit 40 separates the cipher texts (K1, K2, . . . , Ki) in the predetermined unit and scatters and stores the cipher texts separated with reference to the mapping table in the internal memory 50 filled with the random numbers (S1300). The cipher texts scattered and stored in the internal memory 50 in S1300 are copied to the external memory 200 through the internal bus 110 and the external bus 510 of the storage controller 100 (S1400). The internal bus 110 of the storage controller 100 may be used for accessing the internal memory 50, and the external bus 510 of the storage controller 100 may be used for accessing the external memory 200. The data copied to the external memory 200 are identical to the cipher texts scattered and stored in the internal memory 50. The data copied to the external memory 200 in S1400 are stored in the secure area 320 of the storage medium 300 (S1500). The data stored to the secure area 320 are also identical to the cipher texts scattered and stored in the internal memory 50. When the capacity of the internal memory 50 is large enough, the operation executed in S1400 may be omitted. When operation in S1400 is omitted, the cipher texts scattered and stored in the internal memory 50 are stored directly in the secure area 320 of the storage medium 300.

In the method of scattering and storing the cipher texts according to the embodiment of the inventive concept, all of the cipher texts transferred and received in the data storage device 500 are scattered and stored to the random numbers. Therefore, the cipher texts, which are transferred through the internal bus 110 and the external bus 510 of the data storage device 500, are not exposed to the unauthorized access or attack from the outside of the data storage device 500.

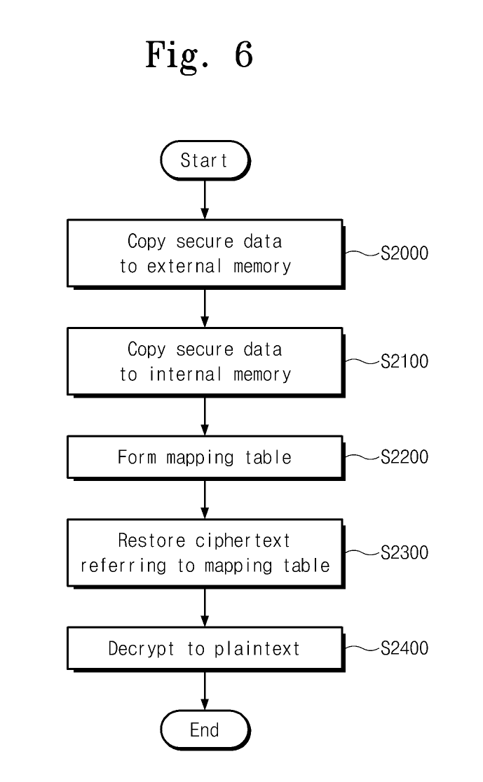

FIG. 6 is a flowchart showing the method for decrypting the cipher text according to the embodiment of the inventive concept. FIG. 6 illustrates the method of decrypting the cipher texts stored in the secure area 320 of the storage medium 300 to the original plain texts in accordance with the method illustrated in FIG. 5.

Referring to FIG. 6, the cipher texts stored in the secure area 320 of the storage medium 300 are copied to the external memory 200 through the external bus 510 of the storage controller 100 (S2000). The data copied to the external memory 200 are identical to the cipher texts scattered and stored to the random numbers. Subsequently, the data copied to the external memory 200 are copied to the internal memory 50 through the external bus 510 and the internal bus 110 of the storage controller 100 (S2100). The external bus 510 of the storage controller 100 accesses the external memory 200, and the internal bus 110 of the storage controller 100 accesses the internal memory 50. The data copied to the internal memory 50 are also identical to the cipher texts scattered and stored to the random numbers. When a great quantity of data is transferred between the external memory 200 and the internal memory 50, the cipher texts may be separated in a predetermined unit to be transferred. In addition, when the size of the internal memory is large enough, the operation in S2000 may be omitted and the cipher texts stored in the secure area 320 may be copied directly to the internal memory 50.

When the cipher texts scattered and stored in the secure area 320 of the storage medium 300 are copied to the internal memory 50, the memory control unit 40 forms the mapping table that is used to restore the cipher text (S2200). The mapping table formed in S2200 may be formed using the unique number defined with each different value for every data storage device 500 as the root key. The mapping table that is used to restore the cipher texts has substantially the same structure as the mapping table that is used to scatter and store the cipher texts. Subsequently, the original cipher texts are restored with reference to the mapping table formed in S2200 (S2300). For example, the 16-byte cipher texts (K1, K2, . . . , Ki) are restored from the 4K-byte data in which the cipher texts are scattered and stored. The restored cipher texts (K1, K2, . . . , Ki) are decrypted to the plain texts (P1, P2, . . . , Pi) by the encryption/description unit 30 (S2400) The operation of restoring the above-described cipher texts and the operation of decrypting the cipher texts to the plain texts may be executed in the storage controller 100.

The data storage device 500 according to the embodiment of the inventive concept does not transfer and receive the cipher texts without changing upon transferring the data through the internal bus 110 and the external bus 510. In the embodiment of the inventive concept, all of the transferred and received cipher texts are scattered and stored to the random numbers. Therefore, the cipher texts, which are transferred through the internal bus 110 and the external bus 510 of the data storage device 500, are not exposed to the unauthorized access or attack from the outside of the data storage device 500.

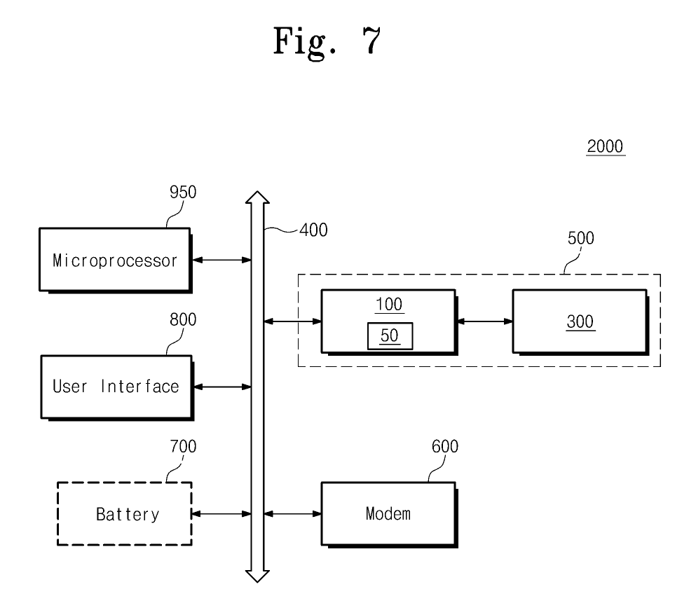

FIG. 7 is a diagram illustrating the configuration of a computing system 2000 according to the embodiment of the inventive concept.

Referring to FIG. 7, the computing system 2000 includes a storage controller 100, a storage medium 300, a modem 600 such as a baseband chipset, a user interface 800, and a microprocessor 950, which are electrically connected to a bus 400, respectively.

The storage controller 100 and the storage medium 300 illustrated in FIG. 7 may form the data storage device 500 illustrated in FIG. 1. The external memory 200 may be provided between storage controller 100 and the storage medium 300. A capacity of the external memory 200 is larger than that of the internal memory 50 provided in the storage controller 100. The data storage device 500 may form an SSD or may form a memory card and/or a memory card system. The detailed configuration of the storage controller 100 and the storage medium 300 illustrated in FIG. 7 is substantially identical to the configuration described in FIGS. 1 and 2. Accordingly, the same reference numerals are denoted to the same components and the duplicated description will be omitted.

In order to securely store and decrypt the encrypted cipher texts without exposing the cipher texts to the outside, the data storage device 500 scatters and stores the cipher texts to the plurality of random numbers and decrypts the scattered and stored cipher texts by using the predetermined algorithm. In this case, since the cipher texts transferred and received through the internal/external buses of the data storage device are mixed with the random numbers, it is possible to securely store and decrypt the cipher texts without exposing the cipher text to the outside.

When the computing system 2000 according to the embodiment of the inventive concept is a mobile device, a battery 700 may further be provided to supply the operation voltage of the computing system 2000. Even though not illustrated in FIG. 7, the computing system 2000 may further include an application chipset, a camera image processor (CIS), a mobile DRAM, or the like. In recent years, the storage medium using different types of nonvolatile memories has a tendency to be mounted in laptop computers, desktop computers, and servers. In such an environment, since the embodiment of the inventive concept has the configuration capable of maximizing the protection of the cipher texts, it is possible to greatly improve an existing security limit and to dramatically expand the base of the storage medium.

According to the embodiment of the inventive concept, the cipher texts are not directly transferred through the internal bus and the external bus of the data storage device, but are transferred such that the cipher texts are scattered and stored to the plurality of random numbers. Therefore, the cipher texts may be stored and decrypted without being exposed to the outside. In addition, the cipher texts may be protected from the unauthorized access or attack from the outside of the data storage device without an additional exclusive process.

The preferred embodiment has been described in the specification with reference to the accompanying drawings. The terminology used therein is for the purpose of describing the embodiment of the inventive concept and is not intended to be limiting of the meaning or limiting of the scope of the inventive concept described in the appended claims. Therefore, the above-disclosed subject matter is to be considered illustrative and not restrictive, and the appended claims are intended to cover all such modifications, enhancements, and other embodiments, which fall within the true spirit and scope of the inventive concept is to be determined by the broadest permissible interpretation of the following claims and their equivalents, and shall not be restricted or limited by the foregoing detailed description.

What is claimed is:

1. A data storage device comprising:
a storage medium that stores a first type of cipher text; and
a storage controller that forms the first type of cipher text by scattering a second type of cipher text in a plurality of random numbers and that transfers the first type of cipher text to the storage medium through an internal bus or an external bus.

2. The data storage device of claim 1, wherein the storage controller includes:
an internal memory accessing through the internal bus;
an encryption/decryption unit forming the second type of cipher text from plain text; and
a memory control unit controlling a reading, erasing, or reading operation of the internal memory and forming the first type of cipher text from the second type of cipher text.

3. The data storage device of claim 2, wherein the memory control unit scatters the second type of cipher text in predetermined areas of the internal memory by using a mapping table.

4. The data storage device of claim 3, wherein the mapping table is formed using a unique number defined with each different value for every data storage device as a root key.

5. The data storage device of claim 3, wherein the mapping table is not stored in the data storage device.

6. The data storage device of claim 3, wherein the memory control unit restores the second type of cipher text from the first type of cipher text by forming a mapping table identical to the formed mapping table used for scattering the second type of cipher text.

7. The data storage device of claim 6, wherein the encryption/decryption unit decrypts the second type of restored cipher text to the plain text.

8. The data storage device of claim 1, further comprising an external memory accessing through the external bus,
wherein the external memory stores the first type of cipher text transferred between the internal memory and the storage medium.

9. A data management method of a data storage device, the method comprising:
forming a mapping table by using a unique number defined with each different value every data storage device as a root key;
allotting predetermined areas of an internal memory;
writing random numbers in the allotted areas;
scattering and storing cipher text to the allotted areas in which the random numbers are written; and
writing the scattered and stored cipher text in a storage medium through an internal bus or an external bus.

10. A data management method of a data storage device, the method comprising:
copying a first type of cipher text from a storage medium to an internal memory through an internal bus or an external bus;
forming a mapping table by using a unique number defined with each different value for every data storage device as a root key;
restoring a second type of cipher text from the first type of cipher text with reference to the mapping table; and
decrypting the second type of restored cipher text to plain text,
wherein the first type of cipher text is formed by scattering and storing the second type of cipher text in a plurality of random numbers.
